(19) United States
(12) Patent Application Publication
(10) Pub. No.: US 2023/0405794 A1
(43) Pub. Date: Dec. 21, 2023

(54) WALNUT TOOL HAMMER HANDLE

(71) Applicant: Wenzhou Guoxin Hardware Tools Co., Ltd., Wenzhou (CN)

(72) Inventors: Bangying HUANG, Wenzhou (CN); Yu ZHANG, Wenzhou (CN); Jianxin ZHANG, Wenzhou (CN)

(21) Appl. No.: 17/889,081

(22) Filed: Aug. 16, 2022

(30) Foreign Application Priority Data
May 30, 2022 (CN) 2022213340660

(51) Int. Cl. B25G 1/01; B25F 1/00

(52) U.S. Cl. CPC B25G 1/01; B25F 1/006

(57) ABSTRACT

A walnut tool hammer handle includes: a hammer handle for connecting a hammer head; a protective sheet installed on a side of the hammer handle close to connecting the hammer head; and prying holes for loosening and tightening screws disposed below the protective sheet and on the hammer handle. The protective sheet is rotatably installed on the side of the hammer handle close to a point where the hammer hand hits, which can use shock resistance and protection properties of the protective sheet to prevent damage to the hammer handle caused by hitting errors, and the prying holes are disposed on the hammer handle to increase practicability of the hammer. Loosening and tightening sheets corresponding to fingers are disposed on a holding part of the hammer handle and are sunken when holding, which makes the fingers have a larger force area, and improves feeling and stability of the holding.

### TECHNICAL FIELD

The disclosure relates to the technical field of hardware tools, and more particularly to a walnut tool hammer handle.

### BACKGROUND

An object used to lap between two items to fasten is called a buckle, and some notebooks or books will close pages of whole notebook or book by the buckle for convenient carrying.

However, the existing notebook either does not have a fixed buckle or the fixed buckle is integrated with the notebook, which cannot be replaced or customarily designed, and sometimes there is no place to place a pen, which is inconvenient, and a used notebook will be directly discarded, and as an integrally formed accessory, the buckle cannot be disassembled, resulting in material waste.

Therefore, it is urgent to provide a walnut tool hammer handle to solve the above-mentioned problem.

### SUMMARY

### Solved Technical Problem

In view of the above shortcomings of the prior art, the disclosure provides a walnut tool hammer handle, which can effectively solve the problem that the buckle on the notebook in the prior art has low flexibility and cannot be disassembled for use at will.

### Technical Schemes

In order to achieve the above purposes, the disclosure achieve the above purposes through the following technical schemes.

The disclosure provides a walnut tool hammer handle, which includes a hammer handle made of hard walnut as a main material. An end of the hammer handle is connected to a hammer head by socket connection. A method of the hammer handle connecting the hammer head is the prior art, and there is not too much detail in this embodiment, and it is not shown in detail in the attached drawings.

The hammer handle includes a protective part and a holding part. A protective sheet is rotatably installed on a side of the hammer handle close to an installation end of the hammer head by a shaft core. The protective sheet is made of sheet-like hard material and is disposed below a hitting position of the hammer head. When the hammer head accidentally falls off or hits empty, the protective sheet reserves as a hitting force point, which can protect the hammer handle.

A shock-absorbing rubber ring is installed on the hammer handle. The shock-absorbing rubber ring is disposed below the protective sheet and fitted with a lower end of the protective sheet. Using the shock-absorbing rubber ring as a bearing point of the protective sheet, which can greatly reduce vibration caused by a hitting force, further protect the hammer handle and prolong a service life of the hammer handle.

When encountering difficult-to-pry screws or embedded screws that need to be loosened in daily use, a coverage of the protective sheet is exposed by rotating the protective sheet. Prying holes for loosening and tightening various screws are disposed on the hammer handle and below the protective sheet. In this embodiment, the prying holes include three equally spaced screw holes with different edges and corners, by inserting the screw to be loosened or an end face of the screw into the prying hole to rotate and disassemble, a use effect of a hammer can be improved. In the actual use process, various types of the prying holes can be added, which are not limited to the numbers and the types of the prying holes illustrated in this embodiment.

In an embodiment, an upper end of the shock-absorbing rubber ring is distributed with anti-slip grains, whether the protective sheet slides out or slides in, it can provide a certain frictional force to limit the movement of the protective sheet and avoid the protective sheet sudden sliding out.

In an embodiment, the hammer handle is provided with a concave limit protrusion, a concave surface of the limit protrusion is faced to a rotating end of the protective sheet, and the limit protrusion is made of hard rubber material and intersects with a rotating track of the rotating end of the protective sheet. The limit protrusion is used to further assist and limit the protective sheet, so as to prevent the protective sheet from sliding out or sliding back to block the prying holes by mistake.

Four loosening and tightening sheets corresponding to four fingers except a thumb of a hand are distributed on a holding part of the hammer handle at equal intervals. When the hand holds the hammer handle, a palm of the hand facing the loosening and tightening sheets holds down, and the four fingers can correspond to the four loosening and tightening sheets respectively. When a force is applied, the loosening and tightening sheet can be concave towards a center of the hammer handle when the hand holds the hammer handle, so as to increase a force surface area between the hand and the hammer handle.

An upper end of the holding part of the hammer handle is provided with four arc-shaped grooves at equal intervals along a length direction of the hammer handle, and each of the loosening and tightening sheets is in an arc-shape groove as a whole and is resiliently stretched-out and drew-back in corresponding one of the arc-shaped grooves.

A middle part of each the arc-shaped groove facing the center of the hammer handle is provided with a limit hole. The limit hole is in a convex shape as a whole. Each the limit hole is provided with a return spring. An end of each the loosening and tightening sheet facing the arc-shaped groove is connected to the return spring through a limit shaft. The limit shaft extends into the limit hole, and a retaining ring with a diameter greater than an outlet diameter of the limit hole is disposed in the limit hole. When hitting, the fingers can exert force to make the fingers press the loosening and tightening sheets to move towards the arc-shaped grooves. Because a thickness of the loosening and tightening sheet is less than a thickness of the arc-shaped groove, a part of the finger can go into the arc-shaped groove, and a force application area of the finger can be increased through a periphery of the arc-shaped groove, which plays a more anti-slip role than traditional smooth holding surfaces or simple anti-slip grain holding surfaces.

In an embodiment, a depth of the arc-shaped groove is twice the thickness of the loosening and tightening sheet. This proportion is not limited in the actual use process, and it can be adjusted in combination with the actual thickness of the hammer handle.

In an embodiment, limit pads made of rubber are disposed in each the arc-shaped groove and are respectively disposed on two sides of each the loosening and tightening sheet. Each of the limit pads and a stretching-out and drawing-back path of the loosening and tightening sheet are arranged in a staggered manner. When the loosening and tightening sheet moves into the groove, two sides of the loosening and tightening sheet can touch the limit pads until the loosening and tightening sheet is completely staggered with the limit pads. When the hitting stops, the limit pads can avoid popping-up of the loosening and tightening sheet and the need to apply more force to make the loosening and tightening sheet pop back. When the hammer handle is not in use, moving the limit pads slightly to pop up the loosening and tightening sheet, and an end face of the loosening and tightening sheet in this embodiment is distributed with anti-slip grains to increase the anti-slip performance.

### Beneficial Effects

Compared with the known public technologies, the technical schemes provided by the disclosure has the following beneficial effects.

The protective sheet is rotatably installed on the side of the hammer handle close to a point where the hammer hand hits, which can use shock resistance and protection properties of the protective sheet to prevent damage to the hammer handle caused by hitting errors, and a certain numbers of the prying holes are disposed on the hammer handle, which can increase the practicality of the hammer. The four loosening and tightening sheets corresponding to the fingers are disposed on the holding part of the hammer handle, thus the loosening and tightening sheets are sunken when the hand holds the hammer handle, the fingers can have a larger force application area when holding the hammer handle, which can improve feeling and stability of the holding.

### BRIEF DESCRIPTION OF DRAWINGS

In order to explain embodiments of the disclosure or the technical schemes in the prior art more clearly, the following will briefly introduce the attached drawings used in the embodiments or the description of the prior art. Apparently, the drawings introduced in the following description are only some of the embodiments of the disclosure. For those skilled in the art, other drawings can be obtained according to these drawings without paying creative labor.

FIG. 1 is a schematic view of an overall structure of a hammer handle according to an embodiment of the disclosure.

FIG. 2 is a schematic side view of the hammer handle according to the embodiment of the disclosure.

FIG. 3 is a schematic view of a movement state of a protective sheet according to the embodiment of the disclosure.

FIG. 4 is a schematic view of a decomposition structure of loosening and tightening sheets according to the embodiment of the disclosure.

FIG. 5 is a schematic view of a side cross-sectional structure of the loosening and tightening sheet according to the embodiment of the disclosure.

FIG. 6 is a schematic view of a side cross-sectional structure of a loosening and tightening sheet according to another embodiment of the disclosure.

FIG. 7 is a schematic view of the loosening and tightening sheets in a state of pressing and receiving force according to the embodiment of the disclosure.

### DESCRIPTION OF REFERENCE NUMERALS

1—hammer handle; 11—shock-absorbing rubber ring; 12—limit protrusion; 13—arc-shaped groove; 131—limit hole; 132—return spring; 133—limit pad; 134—limit shaft; 135—air bag; 2—protective sheet; 21—prying hole; 22—shaft core; 3—loosening and tightening sheet.

### DETAILED DESCRIPTION OF EMBODIMENTS

In order to make the purposes, technical schemes and advantages of the embodiment of the disclosure clearer, the technical schemes in the embodiment of the disclosure will be clearly and completely described below in combination with the attached drawings in the embodiment of the disclosure. Apparently, the described embodiments are part of the embodiments of the disclosure, not all of them. Based on the embodiments in the disclosure, all other embodiments obtained by those skilled in the art without making creative work belong to the scope of protection of the disclosure.

The disclosure is further described below in combination with the embodiments.

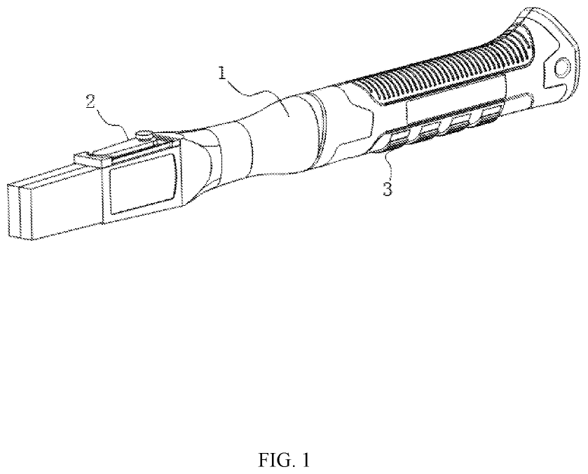

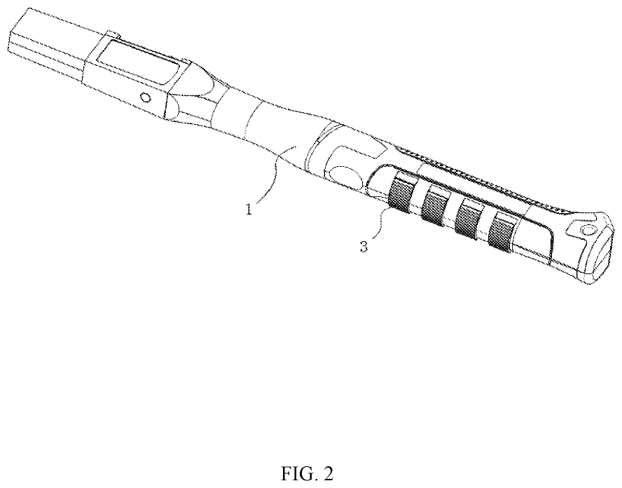

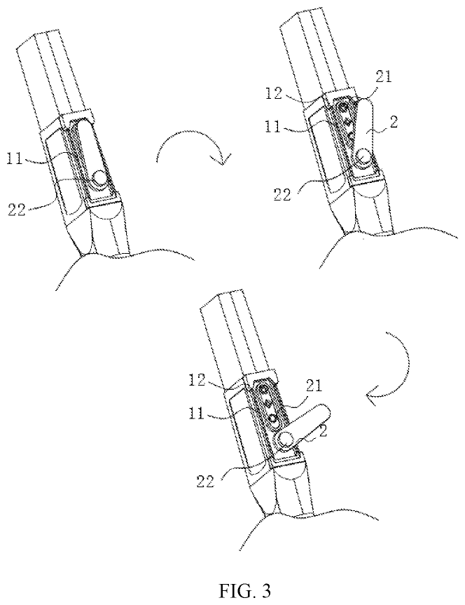

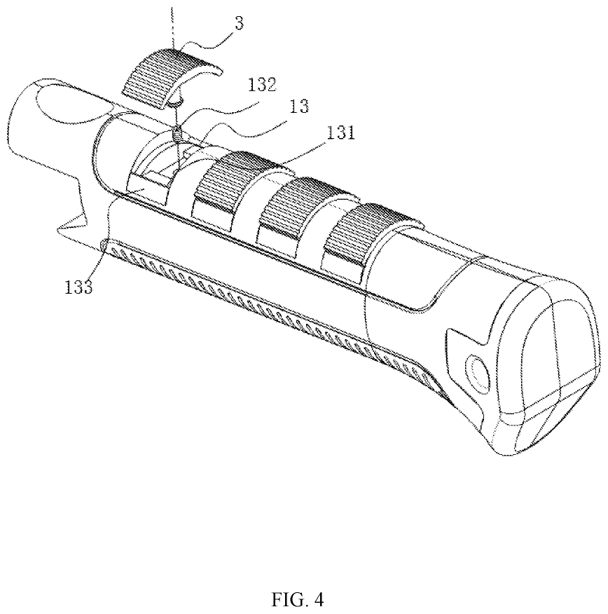

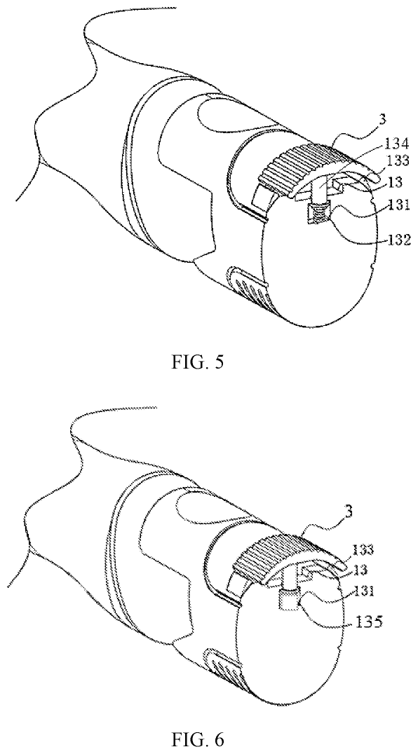

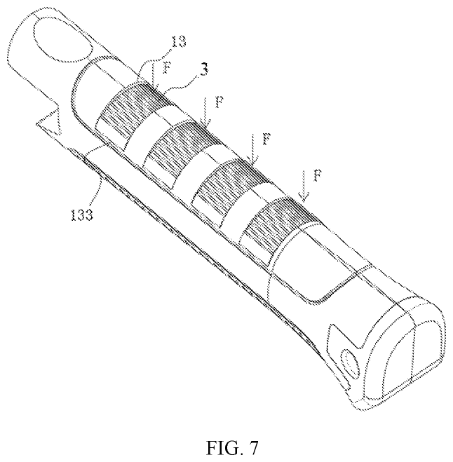

Embodiment: please refer to FIG.1 to FIG. 7, a walnut tool hammer handle includes a hammer handle 1 made of hard walnut as a main material. An end of the hammer handle 1 is connected to a hammer head through socket connection. A method of the hammer handle 1 connecting the hammer head is the prior art, there is not too much detail in this embodiment, and it is not shown in detail in the attached drawings.

The hammer handle 1 includes a protective part and a holding part. A protective sheet 2 is rotatably installed on a side of the hammer handle 1 close to an installation end of the hammer head by a shaft core 22. The protective sheet 2 is made of sheet-like hard material and is disposed below a hitting position of the hammer head. When the hammer head accidentally falls off or hits empty, the protective sheet 2 reserves as a hitting force point, which can protect the hammer handle 2.

A shock-absorbing rubber ring 11 is installed on the hammer handle 1. The shock-absorbing rubber ring 11 is disposed below the protective sheet 2 and fitted with a lower end of the protective sheet 2. Using the shock-absorbing rubber ring 11 as a bearing point of the protective sheet 2, which can greatly reduce vibration caused by a hitting force, further protect the hammer handle 1 and prolong the service life of the hammer handle 1.

When encountering difficult-to-pry screws or embedded screws that need to be loosened in daily use, a coverage of the protective sheet 2 is exposed by rotating the protective sheet 2. Prying holes 21 for loosening and tightening various screws are arranged on the hammer handle 1 and below the protective sheet 2. In this embodiment, the prying holes 21 may include three equally spaced screw holes with different edges and corners, by inserting a screw to be loosened or an end face of the screw into the prying hole to rotate and disassemble, a use effect of a hammer can be improved. In the actual use process, various types of the prying holes 21 can be added, which are not limited to the numbers and the types of the prying holes 21 illustrated in this embodiment.

In other embodiments, positions of screw holes (also referred to as prying holes) can be set at other positions on the hammer handle, which are not limited to the positions shown in this embodiment.

An upper end of the shock-absorbing rubber ring 11 is distributed with anti-slip grains, whether the protective sheet 2 slides out or slides in, it provides a certain frictional force to limit the movement of the protective sheet 2 and avoid the protective sheet 2 sudden sliding out.

The hammer handle 1 is provided with a concave limit protrusion 12, a concave surface of the limit protrusion 12 is faced to a rotating end of the protective sheet 2, and the limit protrusion 12 is made of hard rubber material and intersects with a rotating track of the rotating end of the protective sheet 2. The limit protrusion 12 is used to further assist and limit the protective sheet 2, so as to prevent the protective sheet 2 from sliding out or sliding back to block the prying holes 21 by mistake.

Four loosening and tightening sheets 3 corresponding to four fingers except a thumb of a hand are distributed on a holding part of the hammer handle 1 at equal intervals. When the hand holds the hammer handle, a palm of the hand facing the loosening and tightening sheets 3 holds down, and the four fingers can correspond to the four loosening and tightening sheets 3 respectively. When a force is applied, the loosening and tightening sheet 3 can be concave towards a center of the hammer handle 1 when the hand holds the hammer handle 1, so as to increase a force surface area between the hand and the hammer handle 1.

An upper end of the holding part of the hammer handle 1 is provided with four arc-shaped grooves 13 at equal intervals along a length direction of the hammer handle 1, and each of the loosening and tightening sheets 3 is in an arc-shape groove as a whole and is resiliently stretched-out and drew-back in corresponding one of the arc-shaped grooves 13.

A middle part of each the arc-shaped groove 13 facing the center of the hammer handle 1 is provided with a limit hole 131. The limit hole 131 is in a convex shape as a whole. Each the limit hole 131 is provided with a return spring 132. An end of each the loosening and tightening sheet 3 facing the arc-shaped groove 13 is connected to the return spring 132 through a limit shaft 134. The limit shaft 134 extends into the limit hole 131, and a retaining ring with a diameter greater than an outlet diameter of the limit hole 131 is disposed in the limit hole 131. When hitting, the fingers can exert force to make the fingers press the loosening and tightening sheets 3 to move towards the arc-shaped grooves 13. Because a thickness of the loosening and tightening sheet 3 is less than a thickness of the arc-shaped groove 13, a part of the finger can go into the arc-shaped groove 13, and a force application area of the finger can be increased through a periphery of the arc-shaped groove 13, which plays a more anti-slip role than traditional smooth holding surfaces or simple anti-slip grain holding surfaces.

Referring to FIG. 6, in other embodiments, an air bag 135 can be used to replace the return spring 132 as a shock proof function.

The depth of the arc-shaped groove 13 is twice the thickness of the loosening and tightening sheet 3. This proportion is not limited in the actual use process, and it can be adjusted in combination with the actual thickness of the hammer handle.

Limit pads 133 made of rubber are disposed in each the arc-shaped groove 13 and are respectively disposed on two sides of each the loosening and tightening sheet 3. Each of the limit pads 133 and a stretching-out and drawing-back path of the loosening and tightening sheet 3 are arranged in a staggered manner. When the loosening and tightening sheet 3 moves into the groove, two sides of the loosening and tightening sheet 3 can touch the limit pads 133 until the loosening and tightening sheet 3 is completely staggered with the limit pads 133. When the hitting stops, the limit pads 133 can avoid popping-up of the loosening and tightening sheet 3 and the need to apply more force to make the loosening and tightening sheet 3 pop back. When the hammer handle 1 is not in use, moving the limit pads 133 slightly to pop up the loosening and tightening sheet 3, and an end face of the loosening and tightening sheet 3 in this embodiment is distributed with anti-slip grains to increase the anti-slip performance.

To sum up, the embodiment provides a walnut tool hammer handle including: a hammer handle 1 made of walnut and used for connecting a hammer head; a protective sheet 2 rotatably installed on the side of the hammer handle close to connecting the hammer head, the protective sheet being made of a hard material, prying holes 21 for loosening and tightening screws disposed below the protective sheet 2 and on the hammer handle 1, loosening and tightening sheets 3 disposed on a holding part of the hammer handle 1, each of the loosening and tightening sheets 3 being concave towards a center of the hammer handle 1 when a hand holds the hammer handle 1, so as to increase a force surface area between the hand and the hammer handle 1.

The protective sheet 2 is rotatably installed on the side of the hammer handle 1 close to a point where the hammer hand 1 hits, which can use shock resistance and protection properties of the protective sheet 2 to prevent damage to the hammer handle 1 caused by hitting errors, and the prying holes 21 are disposed on the hammer handle 1 to increase practicability of the hammer. The loosening and tightening sheets 3 corresponding to fingers are disposed on the holding part of the hammer handle 1 and are sunken when holding, which makes the fingers have a larger force area, and improves feeling and stability of the holding.

The above embodiments are only used to illustrate the technical schemes of the disclosure, not to limit it; although the disclosure has been described in detail with reference to the above-mentioned embodiments, those skilled in the art should understand that it can still amend the technical schemes recorded in the above-mentioned embodiments, or equivalently replace some of technical features. These amendments or replacements will not make the essence of corresponding technical schemes separate from the scope of protection of the technical schemes of the embodiments of the disclosure.

What is claimed is:

1. A tool hammer handle, comprising:
a hammer handle; wherein the hammer handle is made of walnut and is configured to connect a hammer head;
a protective sheet, rotatably installed on a side of the hammer handle close to connecting the hammer head; wherein the protective sheet is made of a hard material, the protective sheet is located on the hammer handle, and prying holes for loosening and tightening screws are disposed below the protective sheet; and
loosening and tightening sheets, disposed on a holding part of the hammer handle; wherein each of the loosening and tightening sheets is concave towards a center of the hammer handle when a hand holds the hammer handle, so as to increase a force surface area between the hand and the hammer handle.

2. The tool hammer handle according to claim 1, wherein the protective sheet is rotationally connected to the hammer handle through a shaft core; and
wherein a shock-absorbing rubber ring is installed on the hammer handle, and the shock-absorbing rubber ring is disposed below the protective sheet and fitted with a lower end of the protective sheet.

3. The tool hammer handle according to claim 2, wherein an upper end of the shock-absorbing rubber ring is distributed with anti-slip grains.

4. The tool hammer handle according to claim 1, wherein the hammer handle is provided with a concave limit protrusion, a concave surface of the limit protrusion is faced to a rotating end of the protective sheet, and the limit protrusion is made of hard rubber material and intersects with a rotating track of the rotating end of the protective sheet.

5. The tool hammer handle according to claim 1, wherein an upper end of the holding part of the hammer handle is provided with four arc-shaped grooves at equal intervals along a length direction of the hammer handle, and each of the loosening and tightening sheets is in an arc shape as a whole and configured to be resiliently stretched-out and drew-back in corresponding one of the four arc-shaped grooves.

6. The tool hammer handle according to claim 5, wherein a middle part of each of the four arc-shaped grooves facing the center of the hammer handle is provided with a limit hole, the limit hole is provided with a return spring, and an end of the loosening and tightening sheet facing the arc-shaped groove is connected to the return spring through a limit shaft.

7. The tool hammer handle according to claim 5, wherein a depth of the arc-shaped groove is twice a thickness of the loosening and tightening sheet.

8. The tool hammer handle according to claim 5, wherein limit pads made of rubber are disposed in the arc-shaped groove and are respectively disposed on two sides of the loosening and tightening sheet, and each of the limit pads and a stretching-out and drawing-back path of the loosening and tightening sheet are arranged in a staggered manner.

9. A tool hammer handle, comprising:
a hammer handle, comprising: a protective part and a holding part; wherein the protective part is provided with an installation end configured to connect a hammer head, and the protective part is further provided with prying holes configured to loosen and tighten screws; and the holding part is provided with arc-shaped grooves;
a protective sheet, rotatably installed on the protective part of the hammer handle close to the installation end; wherein the protective sheet is disposed overlying the prying holes at a first rotation state, and the protective sheet expose the prying holes in a second rotation state; and
loosening and tightening sheets, disposed in the arc-shaped grooves of the holding part respectively; wherein each of the loosening and tightening sheets is concave towards a center of the hammer handle and is configured to be resiliently stretched-out and drew-back in corresponding one of the arc-shaped grooves.
